(19) United States
(12) Patent Application Publication
(10) Pub. No.: US 2011/0017008 A1
(43) Pub. Date: Jan. 27, 2011

(54) FINGER MECHANISM OF ROBOT HAND

(76) Inventor: Naoki Kanayama, Nagano (JP)

Correspondence Address: FLYNN THIEL BOUTELL & TANIS, P.C., 2026 RAMBLING ROAD, KALAMAZOO, MI, 49008-1631, US

(21) Appl. No.: 12/735,782

(22) PCT Filed: Feb. 25, 2008
(86) PCT No.: PCT/JP2008/000320

§ 371 Date: Oct. 6, 2010

(51) Int. Cl. B25J 15/08

(52) U.S. Cl. 74/490.03

(57) ABSTRACT

A finger unit (2) of a finger mechanism (1) of a robot hand comprises a tip-side finger link (3), a root-side finger link (4), and a finger joint portion (5) for connecting the tip-side finger link (3) and the root-side finger link (4). The tip-side finger link (3) is constantly applied with torque in the robot hand gripping direction (A) around a finger joint shaft (6) by a torsion coil spring (8), reducing output torque of an electromagnetic motor (7) necessary for driving the finger mechanism (1) in the gripping direction (A). Due to this structure, the finger mechanism of the robot hand which can provide necessary driving force in the robot hand gripping direction using a low-output and compact actuator can be realized.

### TECHNICAL FIELD

The present invention relates to a finger mechanism of a robot hand, and particularly relates to an improvement technique for reducing size and cost.

### BACKGROUND ART

The robot hands disclosed in Patent Documents 1 and 2 have been proposed by the applicant of the present invention as robot hands for grasping and handling objects. With a finger mechanism of a robot hand such as those disclosed in these patent documents, the force for driving the finger in an opening direction may be less than the force required when the finger is driven in a direction for gripping an object, and there is a large difference between the forces required according to the driving directions. However, an electromagnetic motor used to drive a finger joint of the robot hand generates the same torque regardless of the rotational direction. Therefore, in the finger mechanism of a robot hand, an actuator capable of generating drive torque necessary for gripping must be used. For example, in cases in which the gripping direction requires a drive torque three times greater than the torque required in the opening direction, an actuator capable of generating three times the drive torque must be incorporated. To reduce the size and cost of a finger mechanism of a robot hand, it is effective to reduce the size and capacity of the actuator for driving the finger mechanism in the gripping direction and the opening direction.

### [Patent Document 1] JPA 2006-26806

### [Patent Document 2] JPA 2006-26807

### DISCLOSURE OF THE INVENTION

With the foregoing aspects of the prior art in view, it is an object of the present invention to provide a finger mechanism of a robot hand wherein the driving force required in the gripping direction of the robot hand can be obtained using a low-output and compact actuator.

To obtain the object described above, the finger mechanism of a robot hand of the present invention is characterized in comprising:

a root-side finger link and a tip-side finger link constituting a finger of a robot hand;

a finger joint shaft for connecting the tip-side finger link to the root-side finger link in a manner that enables the tip-side finger link to pivot in a gripping direction and an opening direction of the robot hand;

an urging member for constantly urging the tip-side finger link in the gripping direction with a predetermined force; and

a motor for causing the tip-side finger link to pivot about the finger joint shaft in the gripping direction and the opening direction.

A coil spring or torsion spring connected between the tip-side finger link and the root-side finger link can be used as the urging member.

A multi joint finger mechanism of a robot hand of the present invention is characterized in comprising:

a root-side finger link, at least one intermediate finger link, and a tip-side finger link constituting a finger of a robot hand;

a tip-side finger joint shaft for connecting the tip-side finger link to the intermediate finger link in a manner that allows the tip-side finger link to pivot in a gripping direction and an opening direction of the robot hand;

a root-side finger joint shaft for connecting the intermediate finger link to the root-side finger link in a manner that allows the intermediate finger link to pivot in the gripping direction and the opening direction of the robot hand;

a tip-side urging member for constantly urging the tip-side finger link in the gripping direction with a predetermined force;

a tip-side motor for causing the tip-side finger link to pivot about the tip-side finger joint shaft in the gripping direction and the opening direction;

a root-side urging member for constantly urging the intermediate finger link in the gripping direction with a predetermined force; and

a root-side motor for causing the intermediate finger link to pivot about the root-side finger joint shaft in the gripping direction and the opening direction.

Coil springs or torsion springs can be used as the tip-side urging member and the root-side urging member.

In the finger mechanism of a robot hand of the present invention, the tip-side finger link in the finger of the robot hand is constantly urged in the gripping direction of the robot hand by a coil spring or another urging member. Here, provided the following case. To drive the tip-side finger link in the gripping direction requires a driving force three times the opening driving force required in order to drive the tip-side finger link in the opening direction of the robot hand, and the urging force of the urging member constantly subjects the tip-side finger link to a driving force equal to the opening driving force required in order to drive the tip-side finger link in the opening direction.

In this case, the driving force for driving the tip-side finger link in the gripping direction is preferably twice the opening driving force required to drive the tip-side finger link is driven in the opening direction. When the link is driven in the opening direction, the tip-side finger link must be driven against the urging force of the urging member, and twice the opening driving force is therefore required of course. Therefore, the tip-side finger link can be driven in the gripping direction and the opening direction using a motor capable of generating a driving force that is twice the opening driving force, there is no need to use a large and costly motor capable of generating three times the driving force, and the usage efficiency of the motor is improved. Consequently, the finger mechanism is effectively reduced in size and cost.

The same operational effects are obtained even in cases in which the present invention is applied to a multi-joint finger mechanism of a robot hand.

### BRIEF DESCRIPTION OF THE DRAWINGS

FIG. 1 is an explanatory view showing the main portion of a single-joint finger mechanism of a robot hand to which the present invention is applied; and

FIG. 2 is an explanatory view showing an example of a case in which a tension coil spring is used instead of the torsion coil spring in the finger mechanism of FIG. 1.

### DESCRIPTION OF SYMBOLS

1 Finger mechanism of robot hand
2 Finger unit
3 Tip-side finger link
3a Tip portion
3b Rear end portion
4 Root-side finger link
4a Tip portion
4b Rear end portion
5 Joint portion
6 Joint shaft
6a Center axis line
7 Electromagnetic motor
8 Torsion spring
8A Tension coil spring
9, 9A, 10, 10A Spring pegs
A Gripping direction of robot hand
B Opening direction of robot hand

### BEST MODE FOR CARRYING OUT THE INVENTION

An embodiment of a finger mechanism of a robot hand to which the present invention is applied is described hereinbelow with reference to the drawings.

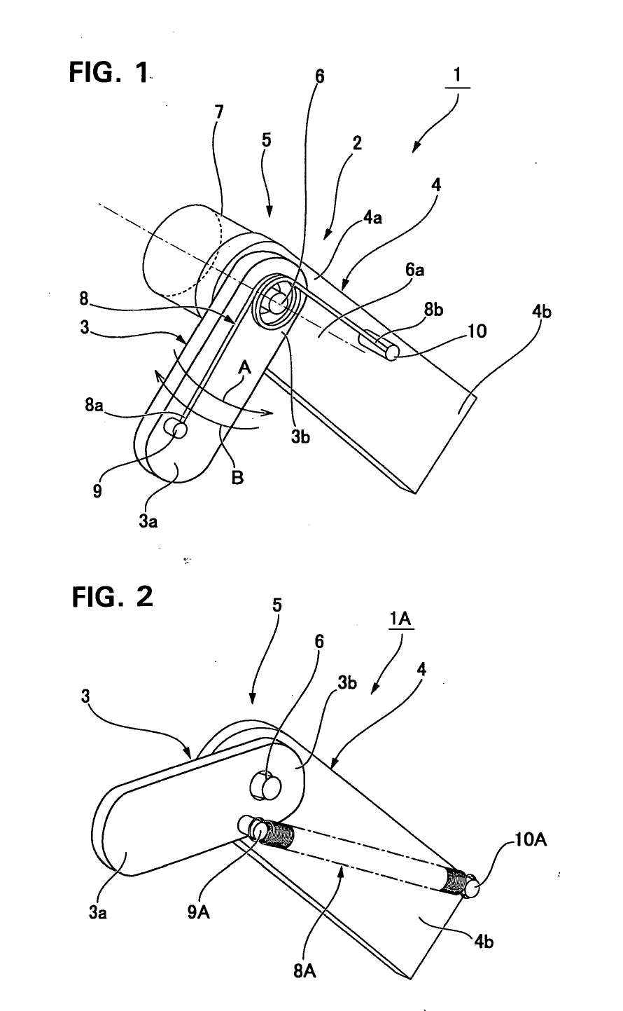

FIG. 1 is an explanatory view showing the main portion in a finger mechanism of a robot hand according to the present embodiment. A finger mechanism 1 of a robot hand comprises one or a plurality of fingers or finger units 2, where only one finger unit is shown in the drawing. The finger unit 2 comprises a tip-side finger link 3, a root-side finger link 4, and a finger joint portion 5 for connecting the links.

The tip-side finger link 3 is formed from a long, thin plate member, for example, and a rear end portion 3b is fixedly connected to a finger joint shaft 6 of the finger joint portion 5, the rear end portion 3b extending in a direction orthogonal to a center axis line 6a of the finger joint shaft 6. When the finger joint shaft 6 is rotated, the tip-side finger link 3 pivots about the finger joint shaft 6 in a gripping direction A and an opening direction B of the robot hand.

The finger joint shaft 6 of the finger joint portion 5 is supported in a rotatable state by a tip portion 4a of the root-side finger link 4. The finger joint portion 5 comprises an electromagnetic motor 7, and the finger joint shaft 6 is rotatably driven by the electromagnetic motor 7. A rear end portion 4b of the root-side finger link 4 is attached in a region forming the palm (not shown) of the robot hand, for example.

A torsion coil spring 8 is arranged on the finger joint shaft 6 so as to enclose the external peripheral surface of the shaft in a coaxial manner. One end 8a of the torsion coil spring 8 is connected to a spring peg 9 fixed to a side surface of a tip portion 3a of the tip-side finger link 3, and the other end 8b is connected to a spring peg 10 fixed to a side surface of a region in the middle of the root-side finger link 4 between the tip portion 4a and the rear end portion 4b. The torsion coil spring 8 causes a spring force to constantly urge the tip-side finger link 3 in the gripping direction A about the finger joint shaft 6.

In the finger mechanism 1 of a robot hand having this configuration, the driving force needed in order to drive the tip-side finger link 3 in the gripping direction A is three times the driving force needed in order to drive the tip-side finger link 3 in the opening direction B of the robot hand. The spring force of the torsion coil spring 8 also causes the tip-side finger link 3 to be constantly subjected to a drive torque equal to the drive torque needed in order to drive the tip-side finger link 3 in the opening direction B.

In this case, the drive torque for driving the tip-side finger link 3 in the gripping direction A may be twice the drive torque for driving the tip-side finger link 3 in the opening direction B. When the tip-side finger link 3 is driven in the opening direction B, the tip-side finger link 3 must be driven against the spring force of the torsion coil spring 8; therefore, as shall be apparent, twice the drive torque is needed. The tip-side finger link 3 accordingly can be driven in the gripping direction A and the opening direction B using the electromagnetic motor 7, which is capable of generating twice the drive torque. Therefore, since there is no need to use a large and costly motor capable of generating three times the drive torque as in conventional practice, the usage efficiency of the motor is improved, and the finger mechanism is effectively reduced in size and cost.

FIG. 2 is an explanatory view showing the main portion of a finger mechanism of a robot hand in a case in which a tension coil spring is used as an urging member for urging the tip-side finger link 3 in the gripping direction. As shown in the drawing, a tension coil spring 8A is fastened in a state of tension between a spring peg 9A attached to the side surface of the rear end portion 3b of the tip-side finger link 3, and a spring peg 10A attached to the side surface of the rear portion 4b of the root-side finger link 4. The finger mechanism 1A of the robot hand configured in this manner achieves the same operational effects as the finger mechanism 1 shown in FIG. 1.

The examples described above are examples of a single-joint finger unit, and it shall be apparent that the present invention can be applied in the same manner to a finger mechanism comprising a multi joint finger unit.

For example, a double-joint finger mechanism may be configured wherein an intermediate finger link is connected between the tip-side finger link 3 and the root-side finger link 4, the intermediate finger link including a tip-side joint portion and a root-side joint portion; the tip-side finger link 3 may be constantly urged in the gripping direction by a tip-side urging member, and the intermediate finger link may be constantly urged in the gripping direction by a root-side urging member. According to this configuration, it is possible to reduce the size of the electromagnetic motor for driving the tip-side finger link as well as an electromagnetic motor for driving the intermediate finger link, which is effective for reducing the size and cost of the finger mechanism.

As described above, in the finger mechanism of a robot hand of the present invention, the tip-side finger link is constantly urged in the gripping direction of the robot hand by a coil spring or another urging member. In the multi-joint finger mechanism of a robot hand of the present invention, the tip-side finger link and the intermediate finger link are constantly urged in the gripping direction of the robot hand by coil springs or other urging members. Therefore, since only a small driving force is needed for driving the tip-side finger link and the intermediate finger link in the gripping direction, low-capacity motors can be used as the drive mechanisms of the finger joint portions. Consequently, the size and cost of the finger mechanism are effectively reduced.

1. A finger mechanism (1) of a robot hand, characterized in comprising:
a root-side finger link (4) and a tip-side finger link (3) constituting a finger (2) of a robot hand;
a finger joint shaft (6) for connecting the tip-side finger link (3) to the root-side finger link (4) in a manner that enables the tip-side finger link (3) to pivot in a gripping direction (A) and an opening direction (B) of the robot hand;
an urging member (8, 8A) for constantly urging the tip-side finger link (3) in the gripping direction (A) with a predetermined force; and
a motor (7) for causing the tip-side finger link (3) to pivot about the finger joint shaft (6) in the gripping direction (A) and the opening direction (B).

2. The finger mechanism (1) of a robot hand according to claim 1, characterized in that:
the urging member is a coil spring (8A) or a torsion spring (8) connected between the tip-side finger link and the root-side finger link.

3. A multi-joint finger mechanism (1) of a robot hand, characterized in comprising:
a root-side finger link (4), at least one intermediate finger link, and a tip-side finger link (3) constituting a finger (2) of a robot hand;
a tip-side finger joint shaft (6) for connecting the tip-side finger link (3) to the intermediate finger link in a manner that allows the tip-side finger link (3) to pivot in a gripping direction (A) and an opening direction (B) of the robot hand;
a root-side finger joint shaft (6) for connecting the intermediate finger link to the root-side finger link (4) in a manner that allows the intermediate finger link to pivot in the gripping direction (A) and the opening direction (B) of the robot hand;
a tip-side urging member (8, 8A) for constantly urging the tip-side finger link (3) in the gripping direction (A) with a predetermined force;
a tip-side motor (7) for causing the tip-side finger link (3) to pivot about the tip-side finger joint shaft (6) in the gripping direction (A) and the opening direction (B);
a root-side urging member (8, 8A) for constantly urging the intermediate finger link in the gripping direction (A) with a predetermined force; and
a root-side motor (7) for causing the intermediate finger link to pivot about the root-side finger joint shaft (6) in the gripping direction (A) and the opening direction (B).

4. The multi-joint finger mechanism (1) of a robot hand according to claim 3, wherein the finger mechanism (1) is characterized in that:
the tip-side urging member is a coil spring (8A) or a torsion spring (8) connected between the tip-side finger link (3) and the intermediate finger link; and
the root-side urging member is a coil spring (8A) or a torsion spring (8) connected between the intermediate finger link and the root-side finger link (4).
